(19) United States
(12) Patent Application Publication
(10) Pub. No.: US 2001/0009367 A1
(43) Pub. Date: Jul. 26, 2001

(54) Sensor device to record speed and motion direction of an object, especially rotational speed and direction of a rotating object

(76) Inventors: Dieter Seitzer, Erlangen (DE); Klemens Gintner, Ludwigsburg (DE)

Correspondence Address: Thomas J. Burger, Wood, Herron & Evans, L.L.P., 2700 Carew Tower, 441 Vine Street, Cincinnati, OH, 45202-2917, US

(21) Appl. No.: 09/790,842

(22) Filed: Feb. 22, 2001

Related U.S. Application Data
(63) Continuation of application No. 60/184,548, filed on Feb. 24, 2000.

(30) Foreign Application Priority Data
Feb. 26, 1999 (DE) 199 08 361.4

(51) Int. Cl. G01B 7/30

(52) U.S. Cl. 324/207.21; 324/207.25; 324/174

(57) ABSTRACT

A sensor device to record the speed and motion direction of an object, especially rotational speed and direction of a rotating object, based on the magnetoresistive effect, is provided with a magnetic field generator (2, 15) coupled to object (1), which generates a locally and time-defined varying reference magnetic field (H), with two magnetic field sensors (SE1, SE2) made of a magnetoresistive material, which are positioned at a stipulated spacing (Δy) from each other relative to magnetic field generator (2, 15) so that they are traversed by magnetic field components (H₁, H₂) of the reference field (H) that are phase shifted relative to each other, in which the phase shift ΔΦ is not equal to an integer multiple of 90°, and with a signal processing circuit (5), which records the magnetoresistive resistance (R_MR1, R_MR2) of the magnetic field sensors (SE1, SE2) dependent on the magnetic field components (H₁, H₂) in the magnetic field sensors (SE1, SE2) and generates from it electrical signals representative of the rotation speed and direction (Uₛ).

The invention concerns a sensor device to record speed and motion direction of an object, especially rotational speed and direction of rotation of a rotating object based on the magnetoresistive effect.

As background to the invention and prior art, it can be stated that the magnetoresistive (AMR) effect, under which the so-called anisotropic magnetoresistive effect and the “giant magnetoresistive effect” fall, permits measurement of magnetic fields. The AMR effect, which is used below as representative for the necessary explanations, occurs in ferromagnetic materials whose electrical conductivity depends on the angle between electrical current density and magnetization of the ferromagnetic material. External magnetic fields can therefore alter the electrical resistance of a magnetoresistive layer, since magnetization is rotated out of the so-called “easy direction”, i.e., the direction of preferred magnetization, by such external magnetic fields.

Strip-like layers of the ferromagnetic material are then essentially used as sensors based on the AMR effect. Because of the shape anisotropy of the magnetoresistive layer stipulated by the strip layer configuration (length>width>>thickness applies for strips) the magnetization vector always lies in the plane of the layer. The layer generally consists of a 20 nm to 80 nm thick layer of the permalloy alloy Ni₈₁Fe₁₉. The maximum obtainable relative resistance changes amount to about 3.5%. The external magnetic field is also applied in the so-called magnetically “hard direction”—the direction of width of the sensor strip.

If the resistance change resulting from application of a magnetic field in the width direction is plotted on a magnetic field/resistance change diagram, a typical bell curve is obtained around the value 0 of the magnetic field. The electrical resistance is greatest for an angle 0 for electrical current density and magnetization and smallest for an angle of 90°. Because of this characteristic the sensitivity of the sensor for small magnetic fields is very small in the width direction of the strip. Because of the bell curve, the characteristic is also indistinct, since the corresponding magnetic field for a certain resistance change can lie parallel or antiparallel to the width direction. Linearization is therefore necessary for sensor application, especially when the sensor is used to determine the absolute value of the magnetic field. As was explained at length in the German Unexamined Patent Application DE 198 10 218 A1 of the applicant, referred to as closest prior art, such linearization is possible by so-called “barber pole” or by applying a magnetic field that overlaps the magnetic field being measured in the magnetically “hard” direction. The overlapped magnetic field can be generated by a permanent magnet or by a current conductor lying parallel to the magnetoresistive strip layer and kept insulated from it. Compensation of the effect of external magnetic fields on the sensor strip during widening of the measurement range and amplification of the output signal of the sensor are also an advantage for absolute measurement, as is also explained at length in the aforementioned document.

For application as a rotational speed sensor, it is sufficient to allocate two at least linearized magnetic field sensor strips to a magnetic multipole wheel rotatable relative to them, in which the sensor strips are arranged at an angle to each other that corresponds to an integer multiple of the pole division of the multipole wheel. The two magnetic field sensors are therefore traversed by the same magnetic field, which oscillates because of rotation of the object being recorded. Thus, there is no phase shift between the resistance changes generated in the sensor strips. The latter can be converted finally into corresponding frequencies and thus rotational speed of the multipole wheel by conversion to voltage signals and digitization.

A shortcoming in the rotational speed recording device demonstrated from DE 198 10 218 A1 is the fact that recognition of direction of rotation does not occur. For many applications of such rotational speed sensors, however, it is quite important to recognize the direction of rotation, for example, in order to select whether a machine or vehicle is running forwards or backwards.

It is also stated that voltage signals are generated and transmitted in the circuitry shown in DE 198 10 218 A1. The sensor devices depicted there and their circuits are therefore only marginally suited for modern vehicle technology, which is increasingly switching to the transmission of current signals with a signal level of, say, 7 mA and 14 mA.

The underlying task of the invention is therefore to offer a sensor device to record the speed of an object, especially the rotational speed of a rotating object, based on the magnetoresistive effect, which also permits recognition of the direction of movement, especially the direction of rotation of the object.

The solution to this task is offered by the features of claim 1. The key feature is positioning of the two magnetic field sensors at a stipulated spacing from each other relative to the magnetic field generator so that the two sensors are traversed by magnetic field components of the reference field phase shifted relative to each other. The phase shift should then preferably be unequal to 0°, 90°, 180°, . . . i.e., unequal to integer multiples of 90°.

Based on the mentioned phase shift of the magnetic field components in the two sensor strips, different magnitudes of the magnetic field components are obtained at each measurement time in the sensor strip so that selective evaluation of direction of rotation is possible by corresponding signal processing. The description of the practical example is referred to for better understanding in this connection.

Preferred variants of the invention are mentioned in the subclaims. The electrical series circuit of magnetic field sensors traversed by constant current is emphasized in particular here, which permits operation of the sensor device with the so-called two-conductor technique. Here again the description of the practical examples is referred to for further understanding, which is provided below with reference to the accompanying drawings. In the drawings:

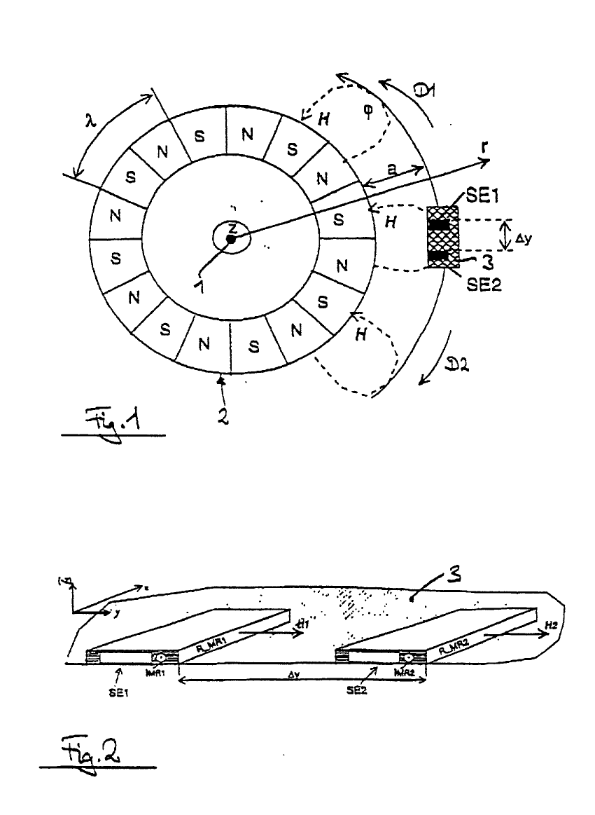

FIG. 1 shows a schematic view of a multipole wheel with sensor device,

FIG. 2 shows a schematic perspective view of two magnetic field sensor strips on a chip carrier in a first variant,

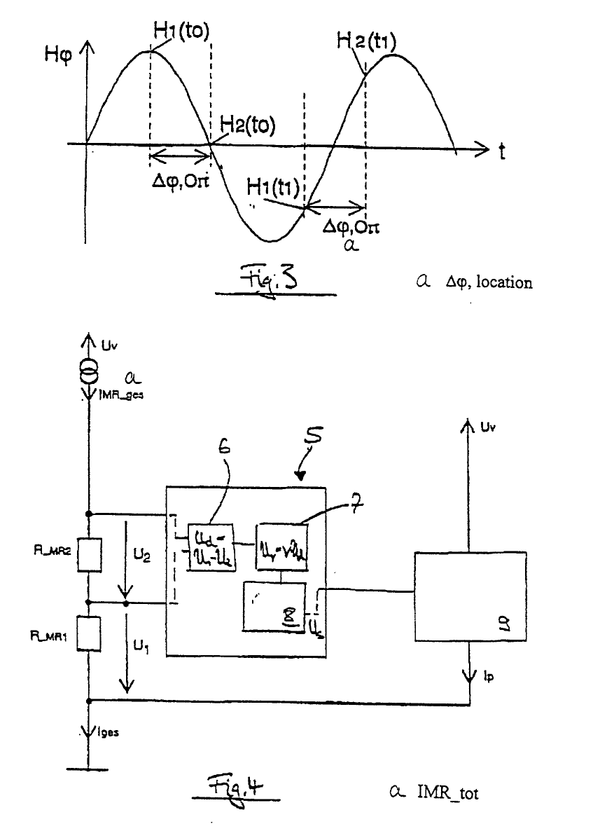

FIG. 3 shows a schematic diagram of the magnetic field trend of the multipole wheel versus time according to FIG. 1,

FIG. 4 shows a block diagram of a sensor device with two magnetic field sensors and a signal processing circuit in a two-conductor technique,

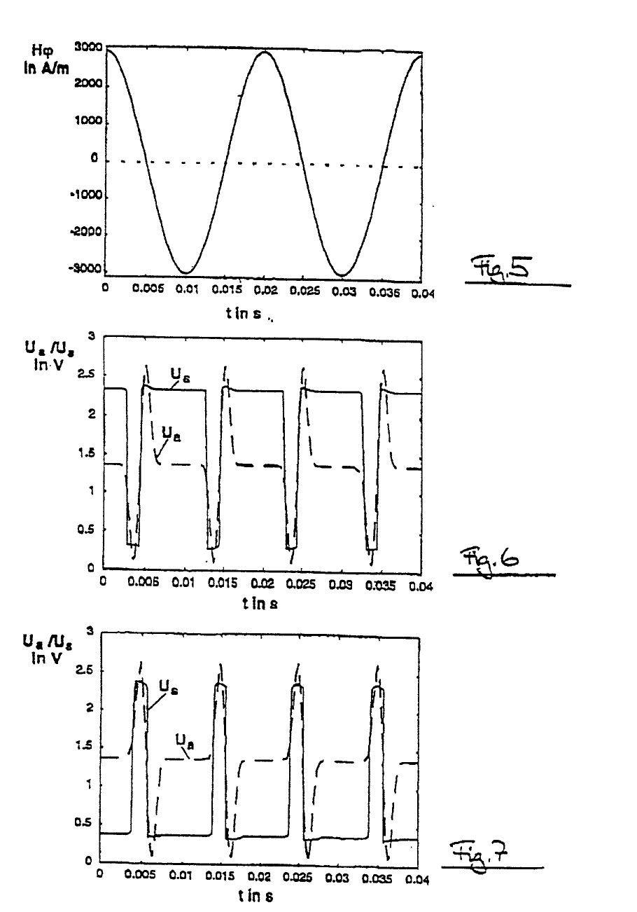

FIG. 5 shows a time diagram of a magnetic field of a multipole wheel,

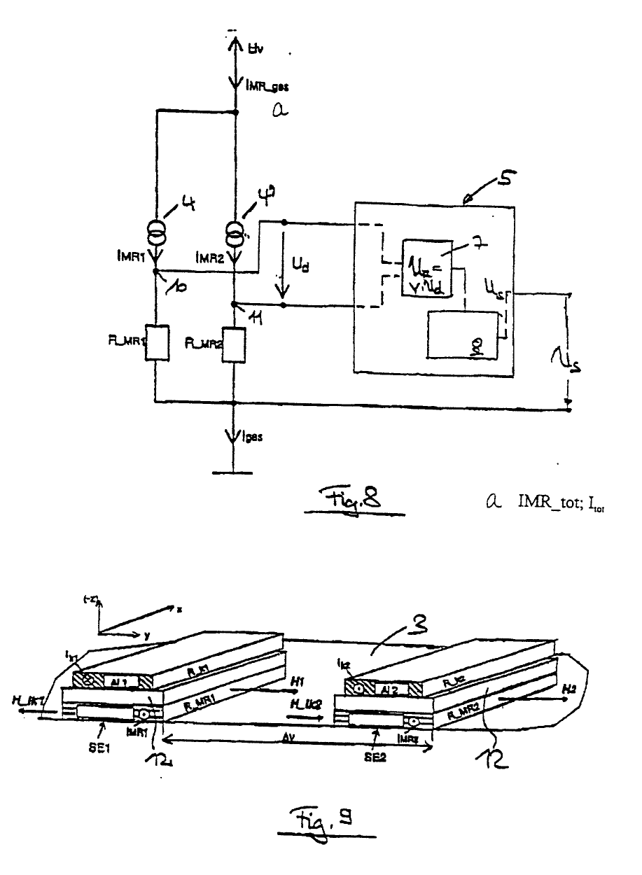

FIGS. 6 and 7 show oscilloscope recordings of analog and digital voltage signals generated by the signal processing device in different directions of rotation,

FIG. 8 shows a block diagram of a sensor device with signal processing circuit in a second variant,

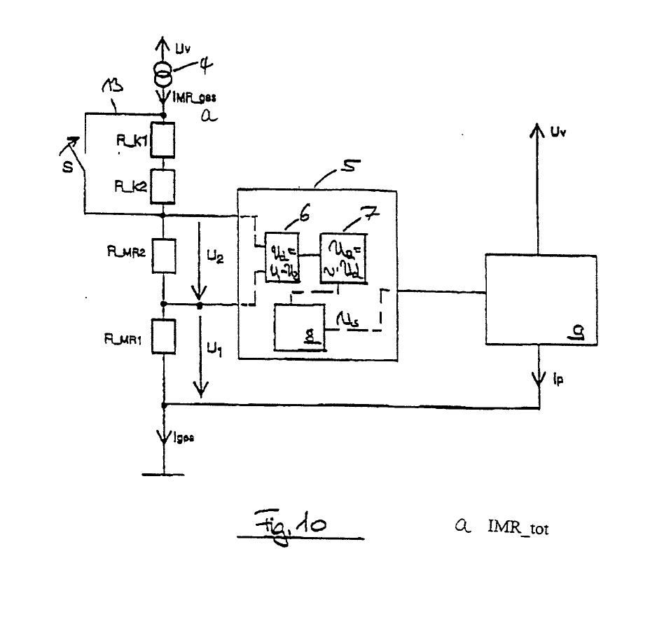

FIG. 9 shows a schematic perspective view of two magnetic field sensors arranged on a chip carrier with current conductors to generate an auxiliary magnetic field,

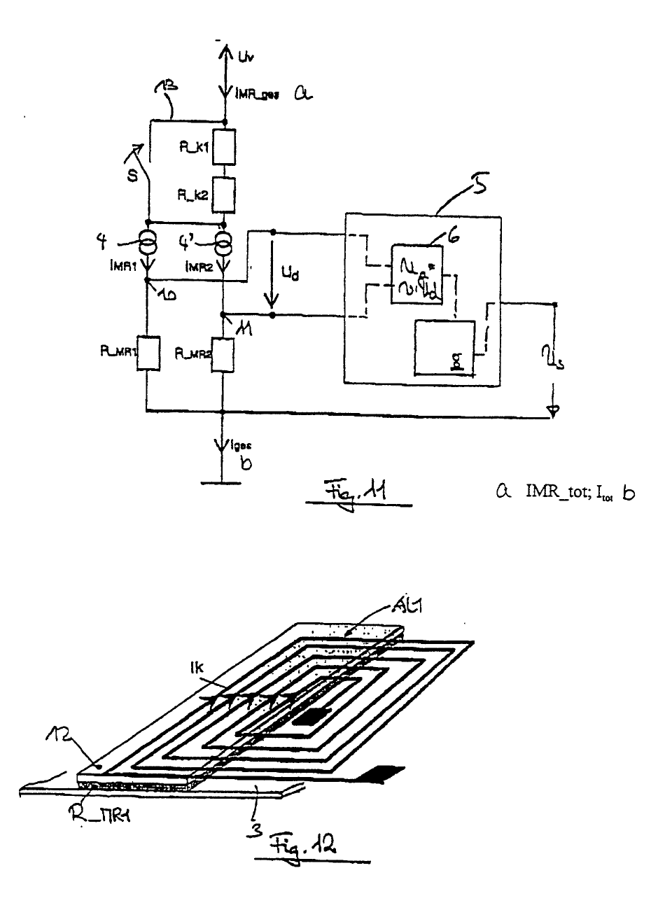

FIGS. 10 and 11 show block diagrams of sensor devices according to FIG. 9 with signal processing circuits in the two-conductor technique or ordinary technique,

FIG. 12 shows a schematic perspective view of a magnetic field sensor with a current conductor applied in a spiral shape to generate an auxiliary magnetic field,

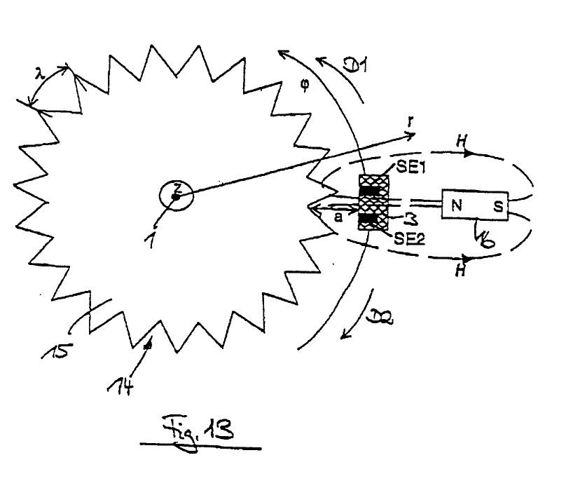

FIG. 13 shows a schematic view of a magnetic field generator with a profiled generator wheel and permanent magnet,

FIG. 14 shows a schematic view of a multipole wheel with a sensor device in a second variant,

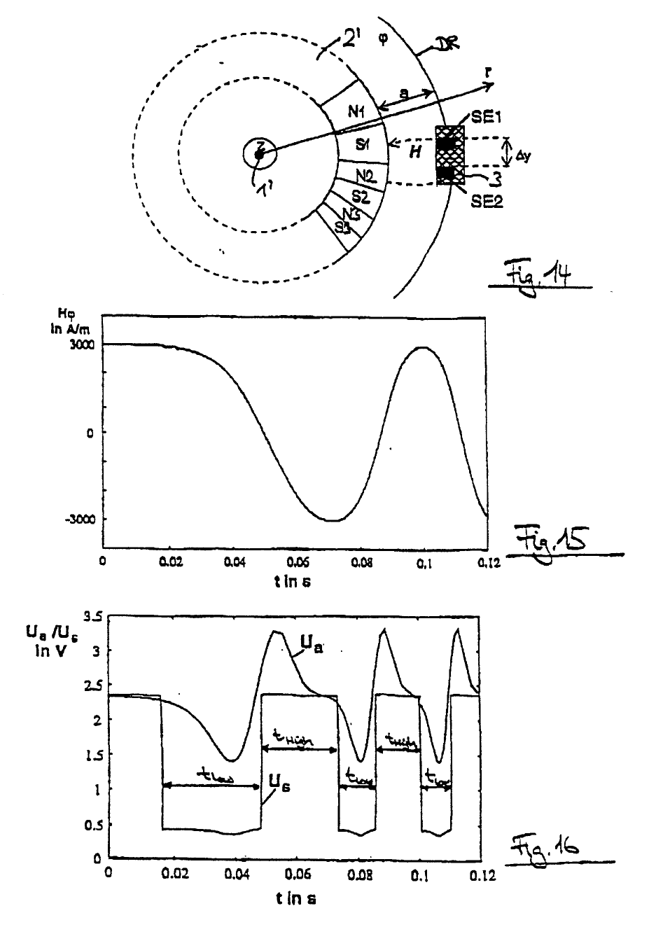

FIG. 15 shows a time diagram of the magnetic field of the multipole wheel according to FIG. 14,

FIG. 16 shows an oscilloscope recording of the analog and digital voltage signal as generated by the signal processing device in an arrangement according to FIG. 14,

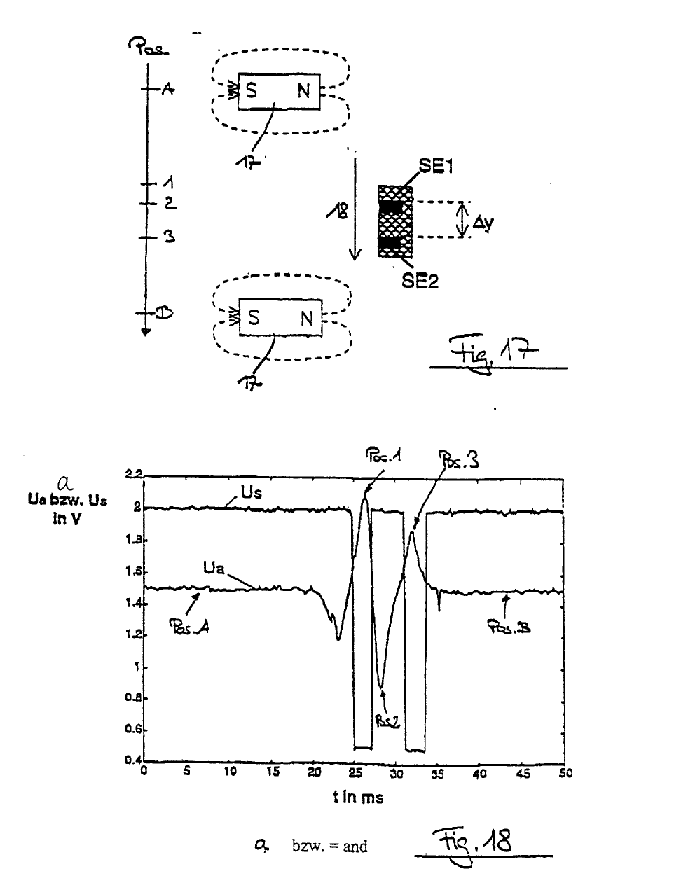

FIG. 17 shows a schematic view of a single permanent magnet as magnetic field generator with sensor device and

FIG. 18 shows an oscilloscope recording of the analog and digital voltage signals generated by the signal processing device in the arrangement according to FIG. 17.

The basic design of a sensor device to record rotational speed and direction of a rotating object is to be explained from FIG. 1. The rotating object, for example, can be a vehicle wheel or a machine part. For the present description it is assumed in the interest of simplicity that a shaft 1 is involved. A so-called multipole wheel 2 is coupled to rotate in unison with this shaft 1, which lies in direction z or is coupled to it via a corresponding gear coupling with a specified gear ratio, which, as a magnetic field generator, generates a locally and time-defined varying reference magnetic field H through alternating north and south poles N, S on its periphery. These opposite magnetic poles alternate with each other on the periphery of multipole wheel 2 with constant spacing B. A reference magnetic field H, which varies in time through rotation of the multipole wheel, therefore forms in the peripheral direction Φ, i.e., varying locally in sinusoidal or cosinusoidal fashion.

The example just sketched concerns recording of rotational speed and direction of a rotating object. However, quite generally the sensor device according to the invention can also be used for linearly moved objects to record their speed and direction of motion. Linearly moved supports and slides of machine tools can be mentioned as examples. A linear arrangement of alternating magnetic poles is then chosen in these as magnetic field generator, these poles then varying also sinusoidally or cosinusoidally along the scale. By motion of the object with the scale attached to it, the reference magnetic field then also varies in time. The following description of the practical example according to FIG. 1 is therefore also gleaned from the preceding case.

A chip carrier 3, on which two ordinary magnetic sensors SE1, SE2 from a magnetoresistant material are arranged at a stipulated spacing Ay relative to each other is arranged in radial direction r at a spacing a. The direction of spacing Ay runs in the peripheral direction Φ.

As is apparent from FIG. 2, the two magnetic field sensors SE1, SE2 are each strips of a ferromagnetic material having strong shape anisotropy. Length l is therefore greater than width b which is much greater than thickness d for each strip. If an electric current IMR1, IMR2 is now passed through such a layer in the direction of length l, the resistance depends on angle θ between the vectors of the electrical current density J and magnetization M. External magnetic fields H₁, H₂ can alter the electrical resistance R₁₃ MR1. R₁₃ NMR2 in the layer because of this. This results from rotation of magnetization M from the so-called magnetically “easy” direction, i.e., the direction of preferred magnetization, which in FIG. 2 is the x direction of the shown coordinate system. The y direction is the magnetically “hard” direction. By measuring the magnetoresistive resistance R_MR1 and R₁₃ MR2 via a corresponding signal processing circuit, as will be further explained with reference to FIG. 4 among others, representative electrical signals can be generated for the rotational speed of multipole wheel 2 and consequently shaft 1.

As is apparent from FIGS. 1 and 3 in this connection, by positioning the two magnetic field sensors SE1, SE2 at a spacing Δy in front of the end of the opposite magnet poles N, S of multipole wheel 2, these sensors are traversed by two magnetic field components H₁, H₂ that are phase shifted relative to each other. At a specified time to, the magnetic field H₁(t₀), for example, is maximal, whereas the magnetic field H₂(t₀) in the second magnetic field sensor SE2 at this time is precisely zero. The corresponding magnetic field components H₁ and H₂ are therefore shifted relative to each other by a specific phase shift “ΔΦlocation”. At time t₁ the negative, i.e.. oppositely directed magnetic field H₁(t₁) prevails in magnetic field sensor SE1, whereas in sensor SE2 the positive magnetic field H₂(t₁) is present. By rotating the multipole wheel with a specific number of rotations, a resistance trend is thus obtained in each magnetic field sensor SE1, SE2 that is determined by the difference magnetic field varying owing to rotation in time-defined fashion.

With the signal processing circuit depicted in FIG. 4, which can be integrated on chip carrier 3, the magnetoresistive resistance R₁₃ MR1, R₁MR2 varied by the magnetic field components H₁, H₂ in the two magnetic field sensors SE1, SE2 can be recorded and electrical signals representative of the rotational speed and direction of multipole wheel 2 or shaft 1 generated from it. For this purpose the two magnetoresistive resistances R₁₃ MR2, R₁₃ MR2 [sic] are connected in series to a constant current source 4 so that the currents IMR1, IMR2 (FIG. 2) through resistances R₁₃ MR1, R₁₃ MR2 are equal to each other and correspond to the total current IMR₁₃ tot.

The signal processing circuit 5 measures the voltage U₁, U₂ dropping over resistances R₁₃ MR1 and R₁₃ MR2 and supplies it to a voltage difference formation circuit 6 and a measurement amplifier 7. A voltage U₀=v(U₁-U₂) is formed, in which v is the amplification factor. The difference voltage U₀ is sent to a connected digitization circuit 8 in the form of a Schmitt trigger so that the output voltage U₃ is formed. With it a switchable current source 9 can be connected whose low level is 0 mA and whose high level is 7 mA. This digitized current signal Iₚ is superimposed with the total current IMR₁₃ tot to a digitized current signal Iₜₒₜ with two levels of 7 mA and 14 mA, which can be evaluated, for example, by a central control unit in a vehicle. This type of signal transmission is also referred to as the two-conductor technique, since only two line connections are necessary in it to supply the corresponding components and for signal transmission.

An example of the signal trend of the sensor device depicted in FIG. 4 is shown in FIGS. 5 to 7. The action and effect of spacing Δy and the related phase shift ΔΦ, location between the two magnet field sensors SE1, SE2 and R₁₃ MR1, R₁₃ MR2 can be explained with it. A cosinusoidal magnetic field H₁₀₀ is assumed, whose maximum amplitude is 3000 A/m (see FIG. 5). The frequency of the magnetic field is 50 Hz, which means that under the assumption that 10 magnetic pole pairs N-S are distributed on the periphery, the multipole wheel rotates with a frequency of 5 Hz. The spacing is set so that the phase shift ΔΦ should lie at +20°. The dashed curve trend depicted in FIG. 6 is obtained as analog output voltage Uₐ. During digitization of this voltage Uₐ by means of a Schmitt trigger, the digital signal Uₛ marked with a solid line in FIG. 6 is generated. The switching thresholds of the Schmitt trigger during conversion to the digital signal Uₛ then lie at 1.55 V from low to high level for rising Uₐ and at 1.20 V for the transition from high to low for falling. As is apparent from FIG. 6. the “unsymmetric” trend of U₃, i.e., the fact that the phase difference ΔΦ, location must not equal 90°, leads to differently long high and low phases of Uₐ. In the output signal a different pulse duty factor (i.e., t_{high}/t_{low}) is thus obtained for the two levels. In rotation direction D1 (FIG. 1) a pulse duration t_{high} of about 8 ms and t_{low} of about 2 ms is obtained. The pulse duty factor t_{high/t}_{low} is therefore 4.

In rotation direction D2 (FIG. 1) in the opposite direction a phase shift ΔΦ, location =-20° is obtained so that the signal trend shown in FIG. 7 for the analog output signal Uₐ (dashed line) and the digital signal Us formed from it (solid line) are formed. The same switching thresholds were again used. As can be gathered from FIG. 7, the pulse duration for the high level thigh in this case is about 2 ms and t_{low} is about 8 ms so that t_{high/t}_{low}=0.25.

As is apparent from a comparison of FIGS. 6 and 7, the rotational speed of the multipole wheel 2 can be determined, on the one hand, from the agreeing frequency of the digital signal Uₛ. The following approximation should then always apply. The rotational speed during a pole change, i.e., t_{high}+t_{low} remains almost constant. The representative electrical signal for the rotation direction that is evaluable accordingly is obtained via the pulse duty factor. It is pointed out that FIGS. 5 to 7 only show examples.

The magnitude of magnetic field H_{Φ} need not amount to 3000 A/m in order to permit clear detection of the rotational speed direction. This depends primarily on the magnetic field sensitivity of the sensor elements SE1, SE2, which is stipulated in the AMR effect mostly by the geometry of the two magonetoresistive strips. However, the amplitude of voltage Uₐ rises with increasing magnetic field up to a saturation point.

The frequency doubling because of the nonlinear characteristic of the AMR effect, i.e., f_{Ua}=F_{Us}=2·(fH₁₀₁) should also be noted. It is further pointed out that the magnetic field sensors SE1 and SE2 are arranged so that the magnetic field H being measured at the location of the magnetoresistive layers is of different size.

The two magnetic field sensors SE1, SE2 in the practical example of the sensor device depicted in FIG. 8 are connected electrically in parallel with their magnetoresistive layers R_MR1 and R_MR2 and are supplied with a constant current I_{MR1} and I_{MR2} from a constant current source 4, 4′. The voltage drop over the two magnetic field sensors R_MR1, R_MR2 is determined by taps 10, 11, between which the difference voltage U_{d} prevails. To this extent the voltage difference formation circuit drops out of the practical example according to FIG. 4. Only a measurement amplifier 7 and a digitization circuit 8 are again provided in order to generate a digital output signal Uₛ. This is again evaluable accordingly in order to determine the rotational speed and direction of multipole wheel 2.

As is already known in principle from DE 198 10 218 A1 mentioned in the introduction, the magnetic field sensors SE1, SE2 can also be provided with linearization, in which auxiliary current conductors A11 and A12 are arranged parallel to the magnetoresistive resistors R_MR1 and R_MR2 separately via an insulation layer 12. These auxiliary conductors are wired so that they are traversed by opposite currents Iₖ₁ and Iₖ₂, which generate a magnetic field H_Ik1 or H_Ik2 superimposed on the magnetic field components H₁, H₂ in the two sensor strips SE1, SE2. As shown in FIG. 9, because of the opposite directions of currents Iₖ₁ and Iₖ₂, the two auxiliary magnetic fields H₁₃ Ik1 and H_Ik2 are directed oppositely. The magnetic field components H₁ and H₂ originating from the multipole wheel therefore need no longer be of different size in order to be able to conduct a rotational speed and direction-sensitive measurement. The magnetic fields H_Ik1 and H₁₃ k2 overlap first additively (H_Ik2) and then subtractively (H₁₃ IK1) with the magnetic field H. Different total values for Hₜₒₜ₁ and Hₜₒₜ₂ are obtained. This is particularly advantageous when an appropriate value for the phase difference ΔΦ, location of the sensors SE1, SE2 cannot be achieved on a chip carrier 3 for reasons of space. Because of magnetic fields H_Ik1 and H_Ik2, the phase shift ΔΦ, location prescribed according to claim 1 between the phase-shifted magnetic field component can also be an integer multiple of 90°.

A wiring and evaluation circuit for the variant of the invention shown in FIG. 9 is depicted in FIG. 10. The auxiliary conductors A11, A12 symbolized by resistors R_k1 and R_k2, as well as the magnetoresistive resistors R_MR2 and R_MR1 of the two magnetic field sensors SE1, SE2 are again shown here in series in a constant current source 4. The measured voltages U1, U2 again diminish over the latter, which are processed by a voltage difference formation circuit 6, a measurement amplifier 7 and a digitization circuit 8 in the form of a Schmitt trigger. The output signal of the Schmitt trigger 8 drives a switchable current source 9 in the already mentioned fashion. Through a parallel branch 13 to the two auxiliary conductors A11, A12, these auxiliary conductors can be bridged by closing the switch S in parallel branch 13. The situation then corresponds to the circuit according to FIG. 4.

Auxiliary conductors A11, A12, which are symbolized in FIG. 11 by the resistors R_k1 and R_k2 connected in series, can again also be used similarly to FIG. 8 in the parallel connected magnetoresistive resistors R_MR1 and R_MR2. These two resistors are again bridged via a parallel branch 13 with switch S. Otherwise, the description of FIG. 8 can be referred to in conjunction with the rest of the circuit, the corresponding components being provided with identical reference numbers.

FIG. 12 schematically depicts that an auxiliary conductor A11 can also be implemented via a magnetoresistive resistor R_MR1 through a conducting path applied to the insulation layer 12 in several loops. Current multiplication and thus an increase in additive magnetic field occurs because of this.

In the practical example depicted in FIG. 13, a magnetic field generator is used in which a magnetic generator wheel 15 with a toothed outer profile 14 moves in the field of a permanent magnet 16. The material of generator wheel 15 varies the field of the permanent magnet 16 so that during rotation of generator wheel 15 a locally and time-defined varying reference magnetic field is again generated. This can be detected by the magnetic field sensors SE1, SE2 in the same manner as described above.

FIG. 14 shows a preferred variant of the sensor device according to the invention in which the absolute position of multipole wheel 2′ and thus shaft 1 is recognizable. As is apparent from the depiction, the magnetic poles are no longer equidistant, but distributed with nonuniform spacings or widths over the periphery of multipole wheel 2′. The peripheral length of the magnetic poles N1, S1 thus constantly diminishes via N2, S2 to N3, S3, etc. A magnetically coded multipole wheel 2′ configured in this way generates the magnetic field HΦ depicted in FIG. 15 during rotation DR in the peripheral direction Φ. If this magnetic field is evaluated by means of the magnetic field sensors SE1, SE2 on chip carrier 3 with an evaluation circuit similar to FIGS. 3 and 7, the signal trend of voltages Uₐ and Uₛ depicted in FIG. 16 is obtained during the phase shift of ΔΦ, location=+20°. As follows from the time-resolved depiction, the time length t_{high} varies while the signal is situated at the high level. Because of the accompanying variation in pulse duty factor, the conclusion can be drawn concerning the absolute position of the multipole wheel. The approach to an almost constant rotation speed during the period t_{high}+t_{low} should then apply again.

Finally, in conjunction with FIGS. 17 and 18 a special application of the sensor device according to the invention will be explained, which can actually be considered the limiting case of speed and motion direction determination described according to the invention Thus, in the extreme case of the signal trend, on passing by a magnetic pole N of the magnetic field generated, for example, by a single permanent magnet 17, it can be determined with high time resolution that the absolute position of the generator can be recognized at least within certain limits. During the passage shown in FIG. 17 with arrow 18 of permanent magnet 17 on the two magnet sensors arranged at “phase shift spacing” Δy, during evaluation similar to FIGS. 4 to 7, we again obtain the signal trend shown in FIG. 18 of the voltages Uₐ and Uₛ. The “microposition” can be determined via the time sequence of the signal, in which the output voltage Uₐ characteristically reveals three positions 1, 2 and 3 between the end positions A and B. A linear movement of the permanent magnet in the vicinity of magnetic field sensors SE1, SE2 can be detected with different positions because of this if the output positions, namely positions A and B are known. The precise number of differentiable positions depends on the number and orientation of the employed permanent magnets and the magnetic fields. Moreover, by using additional sensors and their appropriate arrangement, additional positions can be recognized. The permanent magnet 17 passed by magnetic field sensors SE1, SE2 can also be rotated by 90° so that the “north/south pole axis” lies in the direction of motion.

1. Sensor device for determination of speed and motion direction of an object, especially rotational speed and direction of a rotating object based on the magnetoresistive effect with
a magnetic field generator (2, 15) coupled to the object (1), which generates a locally and time-defined varying reference magnetic field (H),
two magnetic field sensors (SE1, SE2) made of a magnetoresistive material, which are positioned at a stipulated spacing (Δy) relative to each other relative to magnetic field generators (2, 15) so that they are traversed by magnetic field components (H₁, H₂) of reference field (H) that are phase shifted relative to each other, in which the phase shift (ΔΦ) is not equal to a whole number multiple of 90°, and
a signal processing circuit (5), which determines the magnetoresistive resistance (R_MR1, R_MR2) of magnetic field sensors (SE1, SE2) dependent on the magnetic field components (H₁, H₂) in the magnetic field sensors (SE1, SE2) and generates from it electrical signals (Uₛ) representative of the speed and motion direction, especially rotational speed and direction of object (1), characterized by the fact that the signal processing circuit (5) has a voltage difference formation circuit (6) to form the difference (U_{d}) of the magnetic field-dependent voltages (U₁, U₂) diminishing on the magnetic field sensors (SE1, SE2) and a digitization circuit (8) connected after the voltage difference formation circuit (6) for the difference voltage (U_{d}), in which the pulse duty factor of the digital signal (Uₛ) generated by the digitization circuit (8) is evaluable by an evaluation circuit as a criterion for rotational direction (D1, D2) of object (1).

2. Sensor device according to claim 1, in which the magnetic field generator is a multipole wheel (2) with alternating magnetic poles (N, S) that generate an essentially sinusoidally varying magnetic field (H) around the wheel periphery.

3. Sensor device according to claim 1, in which the magnetic field generator is a generator wheel (15) rotating in the field of a permanent magnet (16) with a profiling (14) that varies the magnetic field (H).

4. Sensor device according to one of the claims 1 to 3, in which the two mag-netic sensors (SE1, SE2) are positioned essentially parallel on a common chip carrier (3).

5. Sensor device according to one of the claims 1 to 4, in which the two magnetic field sensors (SE1, SE2) traversed by a constant current (I_{MR}) are electrically connected in series.

6. Sensor device according to one of the claims 1 to 5, in which a switchable current source (9) for signal transmission in the two-conductor technique, controlled by the digital signal (Uₛ) of digitization circuit (8) is connected after signal processing circuit (5).

7. Sensor device according to one of the claims 1 to 6, in which the magnetic field sensors (SE1, SE2) are arranged with the signal processing circuit (5) on a common chip carrier (3).

8. Sensor device especially according to one of the claims 1 to 7, in which each maagnetic field sensor (SE1, SE2) is provided with a current conductor (A11, A12) to conduct an auxiliary current (Iₖ₁, Iₖ₂), which generates in the corresponding magnetic field sensor (SE1, SE2) a constant magnetic field (H_{Ik1}, H_{Ik2}) superimposed on the magnetic field (H) being determined.

9. Sensor device according to claim 8, in which the current conductor (A11, A12) is arranged loop-like to generate the constant magnetic field.

10. Sensor device according to one of the claims 1 to 9, in which the magnetic field generator (2′) is provided with opposite magnetic poles (N1, N2, N3; S1, S2, S3) to recognize the absolute position of generator (2′).

11. Sensor device especially according to one of the claims 1 to 10, in which the magnetic field sensors (SE1, SE2) determine the signal trend during passage of a magnetic pole (N) of magnetic field generator (17) with high time resolution to recognize the absolute position of generator (17).

12. Sensor device according to claim 11, in which the magnetic field generator includes a single permanent magnet (17).
